(19) United States
(12) Patent Application Publication
(10) Pub. No.: US 2026/0208436 A1
(43) Pub. Date: Jul. 23, 2026

(54) COARSE FLAME RETARDANT

(71) Applicant: EOS GMBH ELECTRO OPTICAL SYSTEMS, Krailling (DE)

(72) Inventors: Heiko PFISTERER, Emmering (DE); Andreas HOTTER, Rosenheim (DE); Karl FREIHART, Germering (DE)

(21) Appl. No.: 19/127,334

(22) PCT Filed: Oct. 10, 2023
(86) PCT No.: PCT/EP2023/078027

§ 371 Date: Apr. 3, 2026

(30) Foreign Application Priority Data
Nov. 8, 2022 (DE) 10 2022 129 476.5

(51) Int. Cl. B29C 64/153; B29C 64/314; B29K 105/00; B33Y 10/00; B33Y 40/10; B33Y 70/10; C08K 5/00

(52) U.S. Cl. CPC B29C 64/153; B29C 64/314; C08K 5/0066; B29K 2105/0026; B29K 2105/0088; B33Y 10/00; B33Y 40/10; B33Y 70/10; C08K 2201/005

(57) ABSTRACT

A mixture is described that includes at least one polymer-based material in powder form and at least one halogen-free flame retardant in powder form. The flame retardant in powder form has a particle size distribution with a d50 in the region of 20 to 80 μm, preferably of at least 30 and/or at most 60 μm, and a d10 of greater than 10 μm, preferably greater than 15 μm, more preferably greater than 20 μm. Further disclosed is a method for producing such a mixture, a mixture obtainable by the method, the use of such a mixture as a building material for the additive manufacturing of a three-dimensional object, a three-dimensional object produced by solidifying this mixture, as well as a method and a system for producing such a three-dimensional object.

The invention relates to a mixture comprising at least one polymer-based material in powder form and at least one halogen-free flame retardant in powder form, a method for producing such a mixture, a mixture obtainable by the method, the use of such a mixture as a building material for the additive manufacturing of a three-dimensional object, a three-dimensional object produced by solidifying this mixture, as well as a method and a system for producing such a three-dimensional object.

### PRIOR ART

Methods for manufacturing a three-dimensional object by selectively solidifying a pulverulent material layer-by-layer are used, for example, in rapid prototyping, rapid tooling and additive manufacturing and are known, for example, as ‘laser sintering’ or ‘selective laser melting’. In those, a thin layer of a pulverulent material is repeatedly applied within a building field and the pulverulent material is selectively solidified in each layer by selective irradiation with a laser beam, i.e. pulverulent material is melted at these locations and solidifies to form a material composite. In this way, a three-dimensional object is created. Polymer-based material in powder form, in particular a thermoplastic polymer in powder form, is often used as a building material.

For a wide range of applications for such three-dimensional objects manufactured using the method described above, it is preferred or even essential that these three-dimensional objects have a certain level of flame and fire protection. To achieve this, usually a flame retardant in powder form is admixed with the polymer-based material in powder form and this mixture is used as a building material for the three-dimensional object.

The use of such flame retardants gives the three-dimensional object the desired flame protection, but it is also associated with some disadvantages.

For example, the decomposition temperature of the flame-retardant additives must be lower than that of the matrix material. If economical exposure strategies/energy intakes are used in the laser sintering methods, this often results in heavy smoke formation and at least partial deactivation of the processed flame-retardant additive.

Furthermore, the often finely dispersed additives can act as crystallisation nuclei, and thus the flame-protected three-dimensional objects obtained as a result exhibit a different crystallinity and thus greater distortion or more brittle mechanical properties.

It is also disadvantageous that the reactivity of the flame-retardant additives used also induce a stronger molar mass build-up in the unsintered powder or form a highly viscous shell around the polymer particles, and thereby prevent the flowing.

In light of the prior art described above, there is a need for a mixture comprising at least one polymer-based material in powder form and at least one flame retardant in powder form, which can overcome the disadvantages set out above that are due to the addition of the flame retardant in powder form.

The present invention addresses this need.

### DESCRIPTION OF THE INVENTION

In the investigations underlying this application, it was unexpectedly found that the disadvantages of the prior art described above can be overcome. Specifically, the disadvantages of the prior art described above are overcome by a mixture according to claim 1, a method for preparing such a mixture according to claim 8, by a mixture obtainable by this method according to claim 11, by a three-dimensional object produced by solidifying this mixture according to claim 12, by a method and a system for solidifying this mixture according to claims 13 and 14 and by the use of such a mixture as a building material for the additive manufacturing of a three-dimensional object according to claim 16.

In connection with the aspects of the invention mentioned, it is pointed out that each preferred embodiment described for one aspect is also considered to be a preferred embodiment for the other aspects, even if the combination has not been explicitly described for reasons of clarity. Furthermore, each combination of more or less preferred embodiments of one aspect is considered to be described, as is each combination of more or less preferred embodiments of one aspect with another aspect.

In the context of the present invention, the terms ‘comprising’ or ‘containing’ and their grammatical modifications have the following meanings: In one embodiment, in addition to the elements mentioned, further elements may be included. In another embodiment, essentially only the mentioned elements are included. In other words, in addition to their conventional meaning, the terms can be used synonymously with the terms ‘essentially consisting of’ or ‘consisting of’ in a particular embodiment.

According to a first aspect, the present invention thus relates to a mixture comprising at least one polymer-based material in powder form and at least one halogen-free flame retardant in powder form, wherein the flame retardant in powder form has a particle size distribution with a d50 in the range of 20 to 80 μm, preferably at least 30 and/or at most 60 μm, and a d10 of greater than 10 μm, preferably greater than 15 μm, more preferably greater than 20 μm.

The particle size distribution is preferably determined by laser diffraction (according to ISO 13320:2020).

Alternatively, the particle size distribution can also be determined using dynamic (according to ISO 13322-2:2021) or static image analysis (according to ISO 13322-1:2014).

The polymer-based material in powder form is essentially not limited, but preferably comprises at least one thermoplastic polymer in powder form.

In one embodiment, the polymer-based material in powder form consists for the most part of polymer, e.g. the polymer content in the polymer-based material in powder form is preferably at least 85% by weight, more preferably at least 90% by weight, still more preferably at least 95% by weight, or more than 99% by weight.

In one embodiment, the polymer-based material in powder form consists entirely of polymer.

In one embodiment, the polymer-based material in powder form has a particle size distribution with a d50 in the range of 5 to 200 μm, preferably 20 to 80 μm, more preferably at least 30 and/or at most 60 μm.

In one embodiment, the polymer-based material in powder form has a particle size distribution with a d10 of greater than 10 μm, preferably greater than 15 μm, more preferably greater than 20 μm.

In one embodiment, the polymer-based material in powder form has a particle size distribution with a d50 in the range of 20 to 80 μm, preferably at least 30 and/or at most 60 μm, and with a d10 of greater than 10 μm, preferably greater than 15 μm, even more preferably greater than 20 μm.

The bulk density of the polymer-based material in powder form is preferably 300 to 800 kg/m³, in particular from 400 to 600 kg/m³.

In one embodiment, the flame retardant in powder form has a fines content, determined as the quantity fraction of particles with a particle size smaller than 10 μm, of less than 10%, preferably less than 8%, in particular less than 5%.

In one embodiment, the flame retardant in powder form has a particle size distribution with a d90 of less than 200 μm, preferably less than 100 μm, more preferably less than 80 μm.

In one embodiment, the flame retardant in powder form has an absolute distribution width (d90-d10) of less than 90 μm, preferably less than 60 μm.

In one embodiment, the flame retardant in powder form has a weighted distribution width ((d90-d10)/d50) of less than 4.5, preferably less than 3, more preferably less than 2, and even more preferably less than 1.

In one embodiment, the flame retardant in powder form comprises a phosphorus-based flame retardant, in particular a phosphine-containing, phosphine oxide-containing, phosphinate-containing, phosphonate-containing, phosphite-containing, phosphate-containing, phosphonium-containing and/or polyphosphate-containing flame retardant and/or a flame retardant based on elemental red phosphorus, and/or that the flame retardant in powder form comprises a nitrogen-based flame retardant, in particular melamines or isocyanurates, particularly preferably melamine cyanurate, wherein the phosphorus-based flame retardants are particularly preferred.

Mixtures of different ones of the mentioned flame retardants in powder form are also possible.

Particularly preferred are phosphinate-containing flame retardants comprising a compound of the general formula I

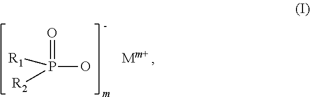

wherein
R₁ and R₂ are independently of each other a linear and/or branched C₁-C₆-alkyl group and/or an aryl residue. The residues R₁ and R₂ may be substituted or non-substituted independently of each other.

M is an alkali metal, an alkaline earth metal, a transition metal, a metal and/or a protonated nitrogen base.

M is preferably selected from Mg, Ca, Al, Sb, Sn, Ge, Ti, Fe, Zr, Ce, Bi, Sr, Mn, Li, Na, K and/or ammonium.

Preferably, R₁ and R₂ are each an ethyl residue.

Preferably, M is Al.

The value of m is obtained from the valency of the cation used in each case and is usually 1, 2, 3 or 4. Mixtures of different cations may also be present.

In particular, aluminium diethyl phosphinate is preferred as a phosphinate-containing flame retardant.

In another embodiment, the flame retardant in powder form is a polyphosphate-containing flame retardant in powder form, in particular an ammonium polyphosphate.

In another embodiment, the flame retardant in powder form is a phosphonate-containing flame retardant in powder form.

To adjust the particle size distribution of the flame retardant in powder form, the flame retardant in powder form can be agglomerated per se. This can increase the sizes of the individual particles.

Alternatively or additionally, the flame retardant in powder form can be agglomerated to a polymeric material. This polymeric material preferably serves as a binder for the flame retardant in powder form. The polymeric material may, for example, comprise a thermoplastic polymer, a thermosetting polymer and/or an elastomeric polymer. The binding with the flame retardant in powder form may, for example, be carried out by softening or melting the polymeric material. Alternatively, the binding with the flame retardant in powder form may also be carried out by inclusion and/or crosslinking.

Preferably, the polymeric material is the material that is also used for the polymer-based material in powder form in the mixture.

The bulk density of the flame retardant in powder form is preferably 20 to 2000 kg/m³, in particular 300 to 700 kg/m³.

Flame retardants on mineral supports sometimes have a high density and thus high bulk densities. Preferably, the density (and also bulk density) of the flame retardant is similar to the density of the polymer powder in order to avoid segregation effects. However, due to the particle shape of the flame retardant, a low bulk density may be present, e.g. in raw form; after mixing with the polymer powder and, if necessary, flow aids, the preferred bulk density can then be achieved.

In one embodiment, the mixture according to the invention is characterised in that the at least one polymer-based material comprises at least one thermoplastic polymer.

Suitable thermoplastic polymers are preferably selected from the group comprising polyetherimides, polycarbonates, polyphenylene sulfones, polyphenylene oxides, polyether sulfones, acrylonitrile-butadiene-styrene copolymers (ABS), acrylonitrile-styrene-acrylate copolymers (ASA), polyvinyl chloride, polyacrylates, polyesters, polyamides, polyaryletherketones (PAEKs), polyethers, polyurethanes, polyimides, polyamide-imides, polysiloxanes, polyolefins, as well as copolymers which have at least two different repeat units of the aforementioned polymers, and/or at least one polyblend on the basis of at least two of the aforementioned polymers and/or copolymers.

In particular, the at least one thermoplastic polymer comprises a polyamide, in particular PA6, PA6.6, PA11, PA12, PA6.13, PA10.12, PA5, PA5.10, a polypropylene-polyethylene copolymer, a thermoplastic polyurethane and/or a thermoplastic polyamide elastomer.

In one embodiment, the mixture according to the invention is characterised in that the bulk density of the mixture is from 300 to 700 kg/m³, preferably from 400 to 600 kg/m³, in particular from 450 to 550 kg/m³.

In another embodiment, the mixture according to the invention is characterised in that the mixture has a monomodal particle size distribution. This means that the particle size distributions of polymer-based material in powder form and the flame retardant in powder form, in particular the respective d50, are essentially identical.

In an alternative embodiment, the d50 of the polymer-based material in powder form deviates by no more than 25 μm, particularly preferably no more than 20 μm, in particular no more than 10 μm, from the d50 of the flame retardant in powder form (and vice versa).

For the implementation of the present invention, it is sufficient if the mixture comprises at least one polymer-based material in powder form and at least one flame retardant in powder form, each as defined above. However, the mixture may further comprise at least one further additive.

Possible additives are preferably selected from the group comprising heat stabilisers, UV stabilisers, flow aids, flow agents, anti-agglomeration agents, anti-discolouration agents, lubricants, nucleating agents, thickeners, antioxidants, antistatic agents, agents for improving biodegradability or biocompatibility, preservatives, dyes, fragrances, hydrolysis stabilisers, fillers, fibres, in particular in the form of glass or carbon fibres, and/or plasticisers, absorbers, in particular carbon blacks or graphite, which absorb in particular in the wavelength range of the radiation source of the processing system.

In another aspect, the present invention relates to a method for producing a mixture as described above.

All the embodiments and definitions described above apply analogously to the method according to the invention.

The method according to the invention comprises adjusting a specific particle size distribution with a d50 in the range of 20 to 80 μm, preferably at least 30 and/or at most 60 μm, and a d10 of greater than 10 μm, preferably greater than 15 μm, even more preferably greater than 20 μm in the flame retardant in powder form and the mixing of this flame retardant in powder form with at least one polymer-based material in powder form.

Since commercially available flame retardants in powder form often have a too large fines content and thus a too small d50, the adjustment of the specific particle size distribution is relevant in order to eliminate the disadvantages of the prior art described at the beginning.

In particular, the fines content leads to poor coating during powder application.

Furthermore, the fines content adheres electrostatically or mechanically to the surface of the polymer particles, envelops them and can thus prevent the spreading/coalescence of the melt.

The adjustment of the specific particle size distribution preferably comprises the mechanical separation of particles, or the sorting out of particles that are too small and/or too large.

In one embodiment, the adjustment of the specific particle size distribution in the flame retardant in powder form comprises the removal of particles, in particular by classification, preferably by sieving, air jet sieving and/or sifting.

Classification and sieving are classic separation methods used in mechanical process engineering. In mechanical process engineering, classification refers to the separation of a disperse solid mixture into fractions, preferably according to the criteria of particle size.

Particularly suitable in this context are the methods outlined in the following.

Screening; in this case the separation is carried out according to characteristic lengths or diameters of the particles by means of a sieve tray with many geometrically approximately the same openings. The sieving can be accelerated by applying an air jet (air jet sieving).

Current classification; in this case, use is made of the different settling velocities or trajectories that the particles achieve or cover in a fluid under the effect of field, flow and inertial forces.

The above-mentioned methods are used in particular when the particle size distribution of a commercially available flame retardant in powder form is to be adjusted.

In one embodiment, the method according to the invention is preferably characterised in that the adjustment of the specific particle size distribution in the flame retardant in powder form comprises a step in which the flame retardant in powder form is agglomerated to itself.

In one embodiment, the method according to the invention is preferably characterised in that the adjustment of the specific particle size distribution in the flame retardant in powder form comprises a step in which the flame retardant in powder form is agglomerated to a polymeric material.

In one embodiment, the method according to the invention is preferably characterised in that the flame retardant in powder form is first compounded with at least one polymeric material and then micronised to the target particle size.

The polymeric material used for the agglomeration and/or compounding preferably serves as a binder for the flame retardant in powder form. The polymeric material may, for example, comprise a thermoplastic polymer, a thermosetting polymer and/or an elastomeric polymer.

The binding with the flame retardant in powder form may, for example, be carried out by softening or melting of the polymeric material. Alternatively, the binding with the flame retardant in powder form can also be carried out by inclusion and/or crosslinking.

Preferably, the polymeric material is the material that is also used for the polymer-based material in powder form in the mixture.

In one embodiment, the method according to the invention is preferably characterised in that the adjustment of the specific particle size distribution in the flame retardant in powder form comprises a step wherein the flame retardant in powder form is agglomerated by precipitation or drying from a dispersion or solution.

It is also possible to combine several of the above-mentioned method steps.

In another aspect, the present invention relates to a mixture obtainable by the methods described above.

All the embodiments and definitions described above apply analogously to the mixture obtainable by the method described above.

In another aspect, the present invention relates to a three-dimensional object, produced by solidifying a pulverulent building material at spatial points corresponding to the cross-section of the three-dimensional object in the respective layer, by irradiation, wherein a mixture as described above and/or a mixture obtainable by the method described above is used as the building material.

All the embodiments and definitions described above apply analogously to the three-dimensional object.

In another aspect, the present invention relates to a method for producing a three-dimensional object, in particular by solidifying a pulverulent building material at the points corresponding to the cross-section of the three-dimensional object in the respective layer, wherein a mixture as described above and/or a mixture obtainable by the method described above is used as the building material and preferably the building material is selectively solidified by the action of electromagnetic radiation emitted from a radiation source.

All the embodiments and definitions described above apply analogously to the method for producing a three-dimensional object.

In a preferred embodiment, the method is a conventional laser sintering method that uses a CO₂ laser or a light source that emits short-wave radiation, such as NIR radiation. In this method, the mixture is regularly applied layer by layer onto a base or building platform and the locations where a subsequent object is to be created are solidified by activation/melting with a laser beam or a set of two or several laser beams.

In another embodiment, the solidification is carried out by applying an ink to the parts of the layer in which the object is to be created later, and then irradiating the surface of the layer with a two-dimensional light source of a wavelength that is absorbed only by components of the ink. In the process the mixture ‘marked’ with the ink is selectively melted and can then be solidified into a three-dimensional object. This type of method is marketed by the company HP as ‘Multi Jet Fusion’.

As already mentioned, the wavelength of the radiation source is not subject to any relevant restriction, provided that it enables selective melting of the desired regions of the layer or positions of the mixture. In one embodiment, the radiation source is a conventional CO₂ laser with a radiation wavelength of about 10.6 μm.

In another embodiment, the radiation source emits electromagnetic radiation of a wavelength in the range of 400 to 1500 nm, preferably in one of the wavelength ranges 1064±8 nm and/or 980±7 nm and/or 940±7 nm and/or 810±7 nm and/or 780±10 nm and/or 640±7 nm, or electromagnetic radiation of a wavelength of about 10.6 μm or in the range of 4.8 to 8.3 μm and preferably about 5 μm.

The radiation source to be used in the method preferably comprises at least one laser, preferably at least one diode laser.

In a further aspect, the present invention relates to a system for manufacturing three-dimensional objects by solidifying a pulverulent building material at the locations in the respective layer that correspond to the cross-section of the three-dimensional object, wherein the system comprises at least one radiation source that is designed to emit electromagnetic radiation, a process chamber that acts as an open container and which is formed with a container wall, a support arranged in the process chamber, wherein the process chamber and the support are movable in vertical direction relative to each other, with a storage container and a coater movable in a horizontal direction, wherein the storage container is at least partially filled with a mixture as described above and/or a mixture obtainable by the method described above.

All the above-described embodiments and definitions apply analogously to the system for producing three-dimensional objects.

A conventional system and method that can be used in the context of the invention is, for example, known from DE 44 10 046, in which a three-dimensional object is produced by repeated application of powder layers, selective melting (partially or completely) on the respective positions corresponding to the cross-section of the object and subsequent solidification of the melt in layers-according to the principle of ‘additive manufacturing’. By melting the powder layer, the melt fuses with the previously melted layer. An example of a laser sintering device with a laser beam and a deflecting mirror is shown in FIG. 1.

As can be seen in FIG. 1, the device has a container 1 that is open at the top and is bounded at the bottom by a support 4 for supporting an object 3 to be formed. A working plane 6 is defined by the upper edge 2 of the container (or its side walls). The object is located on the upper side of the support 4 and is formed from several layers of a pulverulent building material that can be solidified by electromagnetic radiation and extends parallel to the upper side of the support 4. The support is vertically adjustable, i.e. parallel to the side wall of the container 1. This allows the position of the support 4 to be adjusted relative to the working plane 6.

An application device 10 for applying the powder material 11 to be solidified onto the building platform 5 or a layer that was last solidified is provided above the container 1 or the working plane 6. Furthermore, an irradiation device in the form of a laser 7 is arranged above the working plane 6, which emits a directed beam of light 8. This is deflected by a deflecting device 9, for example a rotating mirror, as a deflected beam 8′ in the direction of the processing plane 6. This arrangement is common in a laser sintering system with a CO₂ laser. A control unit 40 allows the control of the support 4, the application device 10 and the deflection device 9. Elements 1 to 6, 10 and 11 are arranged within the machine frame 100.

In the production of the three-dimensional object 3, the powder material 11 is applied in layers to the support 4 or to a previously solidified layer and solidified by the laser beam 8′ at the positions corresponding to the object in each powder layer. After each selective solidification of a layer, the support is lowered by the thickness of the powder layer to be applied next.

In the system described above, the radiation source preferably emits electromagnetic radiation of a wavelength in the range of 400 to 1500 nm, preferably in one of the wavelength ranges 1064±8 nm and/or 980±7 nm and/or 940±7 nm and/or 810±7 nm and/or 780±10 nm and/or 640±7 nm, or electromagnetic radiation of a wavelength of about 10.6 μm or in the range of 4.8 to 8.3 μm and preferably about 5 μm.

The radiation source to be used in the system preferably comprises at least one laser, preferably at least one diode laser.

The laser diodes can be arranged in a cellular or staggered fashion. Furthermore, it is possible that the laser diodes are arranged in a two-dimensional array. The emitter can be an edge emitter. Preferably, the emitter is a surface emitter (VCSEL or Philips VCSEL). High building speeds can be achieved by line exposure. Furthermore, the use of laser diodes enables a high degree of efficiency and reduces energy costs.

Suitable laser diodes generally operate at a power between 0.1 and 500 watts, preferably at least 1.0 watt and/or at most 100 watts. The focus of the laser beam may have a radius between 0.05 mm and 1 mm, preferably of at least 0.1 mm and/or at most 0.4 mm.

The exposure speed, i.e. the speed of the laser focus relative to the building plane, is usually between 10 mm/s and 20000 mm/s, preferably at least 300 mm/s and/or at most 10000 mm/s, particularly preferably at most 6000 mm/s.

In a further aspect, the present invention relates to the use of a mixture as described above and/or a mixture obtainable by the method as described above as building material for the additive manufacturing of a three-dimensional object by selective solidification of a building material at the cross-section points of the three-dimensional object in the corresponding layers, in particular as described above.

All the embodiments and definitions described above apply analogously to the use according to the invention.

### DESCRIPTION OF THE FIGURES

FIG. 1 shows an example of a conventional laser sintering apparatus for the layer-by-layer production of a three-dimensional object.

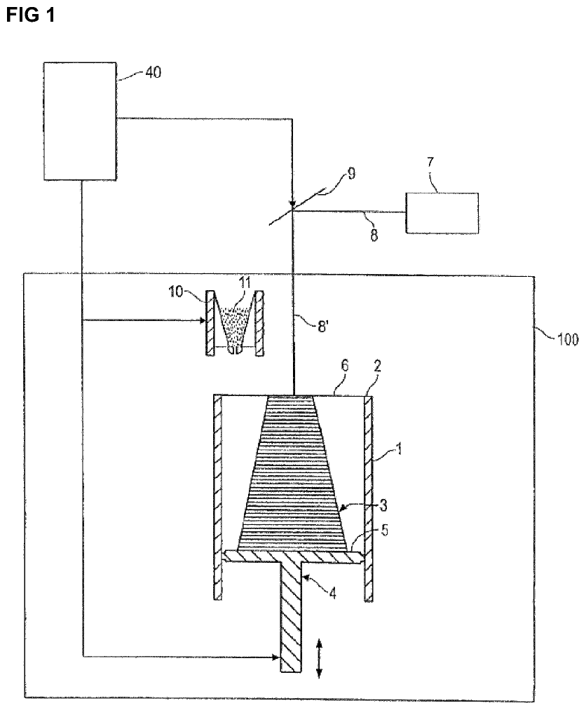

In the following, the present invention is described in more detail by means of examples, which, however, are for illustrative purposes only and are in no way to be understood as a limitation of the invention described herein.

### EXAMPLES

### Example 1

A commercially available phosphinate-based flame retardant of the type EXOLIT® OP 1400 from Clariant is fractionated by means of air jet sieving with a laboratory sieve SLS 200 from Siebtechnik GmbH with a downstream cyclone separator using a 32 μm sieve and an applied vacuum of 70-90 mbar.

This produces the following fractions of the flame retardant:

F1 describes the unfractionated material, F2 describes the sieving residue after sieving, F3 describes the collected through fraction after cyclone separation.

The air jet sieving removes around 30-40% of the feed material as through fraction from the feed material.

A chemically comparable flame retardant FN with significantly smaller particle diameters, available as EXOLIT® OP 930 from Clariant, is used as a non-inventive comparative example.

The material obtained is realized using laser diffraction according to ISO 13320:2020 with a CILAS 1064 measuring instrument from the company Quantachrome Particle Measurement Technology with a wet dispersion cell in water with the addition of a dispersing medium (surfactant). During wet dispersion, the sample is additionally dispersed using ultrasound. The measurement analysis of the particle size distribution is carried out according to the Fraunhofer model. The particle size distribution is given as d10, d50 and d90, i.e. as the 10% quantile, 50% quantile and 90% quantile of the volumetric particle size distribution. In addition, the fines content is given as the proportion of particles with a diameter x<10 μm. The measurement is carried out several times to statistically determine the mean value.

In addition, the bulk density is determined based on ISO 60 and the flowability in accordance with ISO 6186 at a discharge nozzle diameter of 15 mm.

The measured data obtained are shown in Table 1.

TABLE 1
Flame retardants

| | laser diffraction | | | | |
|---|---|---|---|---|---|
| | x < 10 μm | d10 | d50 | d90 | bulk density |
| | [%] | [μm] | [μm] | [μm] | [kg/m³] |
| F1 | 16.1 | 5.5 | 31.3 | 49.3 | 519 |
| F2 | 9.9 | 10.3 | 35.5 | 53.3 | |
| F3 | 39.3 | 1.8 | 14.1 | 28.9 | |
| FN | 98.7 | 0.9 | 3.3 | 7.6 | 340 |

The flame retardants F1 and F3 obtained in this way do not have the properties preferred according to the invention, in particular with regard to the amount of fines content and the combination of d10 and d50. Only F2 meets these requirements.

The flame retardants obtained in this way are mixed with a commercially available polyamide 12 fine powder, VESTOSINT® 1125 white from Evonik, in a proportion of 25% (mass fraction of the flame retardant in the mass of the total mixture). In addition, 0.05% (mass fraction of the flow agent in the mass of the total mixture) of AEROXIDE® Alu C is added as a flow agent. The mixing is carried out at room temperature in a laboratory mixer Lab CM 12-MB using short mixing tools and a mixing sequence of 2 minutes at 300 rpm and then 1 minute at 500 rpm. The resulting mixtures are sieved with a laboratory sieve, mesh size 250 μm, to remove agglomerates and impurities.

The corresponding mixture with the flame retardant F1 is referred to in the following as M1, with the flame retardant F2 as M2 and with the flame retardant F3 as M3.

The unadditivated polymer powder VESTOSINT® 1125 white is listed as reference under the designation M0. A mixture of FN with the polyamide powder is not considered further in the context of this example, since preliminary tests with corresponding mixtures have shown that this powder cannot be dispensed or applied with an EOS P 396 laser sintering system. Furthermore, mixtures M1 and M3 cannot be used as comprehensive examples of the invention, since they do not include all the preferred embodiments.

The mixtures were also analysed using the measurement methods described above. The analysis data are shown in Table 2.

TABLE 2
Mixtures

| | laser diffraction | | | | bulk | flow- |
|---|---|---|---|---|---|---|
| | x < 10 μm | d10 | d50 | d90 | density | ability |
| | [%] | [μm] | [μm] | [μm] | [kg/m³] | [s] |
| M0 | 3.6 | 34.5 | 57.0 | 84.8 | 451 | non- |
| | | | | | | flowable |
| M1 | 6.8 | 18.4 | 51.5 | 80.2 | 500 | 34 |
| M2 | 5.0 | 26.4 | 52.7 | 80.5 | 504 | 27 |
| M3 | 8.4 | 12.3 | 51.9 | 82.2 | 503 | 70 |

Particularly striking is the increased flow time when determining the flowability for M3, which contains the highest fines content. This indicates poorer flow behaviour of the material, which has a negative effect on powder feeding, dosing and application when processing the powder mixture in a powder-based additive manufacturing method.

Mixtures M1, M2 and M3 are processed on a modified EOS P 396 laser sintering system. The modifications are limited to a reduced building volume to a building space of 125 mm×110 mm×85 mm, centred in the original building field. Accordingly, the heating elements are adapted for an even temperature distribution in the building field. The dosing containers and the coater with the coating blade (EOS Klinge III) obtain an corresponding insert, so that powder is only applied in the relevant building field. The processing is carried out at a layer thickness of 120 μm and an exposure parameter with a volume-related energy input of 0.26 J/mm³, divided into two exposures with half the energy input per exposure, wherein the applied laser power is 18.5 W and the scanning speed 6 m/s. The process chamber temperature is 179° C. (measured by the modified temperature measurement system; a typical deviation of about 10° C. compared to unmodified systems was observed), the removal chamber temperature is 150° C. To determine the mechanical properties, type 1BA tensile bars in accordance with ISO 527-2 are produced with a nominal thickness of 2.5 mm in a horizontal component orientation (XYZ). In the vertical component orientation (ZXY), tensile bars of type A23 according to ISO 20753 are manufactured with a nominal thickness of 2.0 mm. The specimens manufactured in this way are tested on a Zwick/Roell Z005 tensile testing machine with extensometers.

The characteristic values determined are listed in Table 3.

TABLE 3
Mechanical properties

| | XYZ component orientation | | | ZXY component orientation | | |
|---|---|---|---|---|---|---|
| | E | tensile | elongation | E | tensile | elongation |
| | modulus | strength | at break | modulus | strength | at break |
| | [MPa] | [MPa] | [%] | [MPa] | [MPa] | [%] |
| M1 | 1755 | 23.3 | 5.1 | 1762 | 23.2 | 4.0 |
| M2 | 1847 | 23.6 | 4.8 | 1710 | 23.6 | 5.9 |
| M3 | 1600 | 22.2 | 4.2 | 1597 | 23.2 | 3.5 |

In particular for components in ZXY component orientation, it is clear that only material M2 can achieve high elongation at break. Due to a poorer powder application behaviour of the other powders and due to a partial deterioration of the flowing of the molten polymer particles due to a shielding effect of the fine flame retardant particles, the coalescence of the melt, in particular also between the layers, is reduced. As a result, also the overall reduced mechanical properties of the test specimens made of M3 are to be derived in particular.

1. Mixture comprising at least one polymer-based material in powder form and at least one halogen-free flame retardant in powder form, characterised in that the flame retardant in powder form has a particle size distribution with a d50 in the region of 20 to 80 μm, and a d10 of greater than 10 μm.

2. Mixture according to claim 1, characterised in that the flame retardant in powder form has a fines content, determined as the quantity fraction of particles with a particle size of less than 10 μm, of less than 5%.

3. Mixture according to claim 1, characterised in that the flame retardant in powder form has a particle size distribution with a d90 of less than 80 μm.

4. Mixture according to claim 1, characterised in that the flame retardant in powder form is a phosphine-containing, phosphine oxide-containing, phosphinate-containing, phosphonate-containing, phosphite-containing, phosphate-containing, phosphonium-containing and/or polyphosphate-containing flame retardant and/or a flame retardant based on elemental red phosphorus, and/or that the flame retardant in powder form comprises a nitrogen-based flame retardant.

5. Mixture according to claim 4, characterised in that the flame retardant in powder form comprises a compound of general formula I 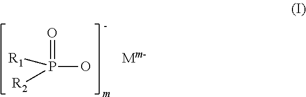
wherein
R1 and R2 are independently of each other a linear and/or branched C1-C6-alkyl residue, and
M is an alkali metal, an alkaline earth metal, a transition metal, a metal and/or a protonated nitrogen base, selected from the group consisting of Mg, Ca, Al, Sb, Sn, Ge, Ti, Fe, Zr, Ce, Bi, Sr, Mn, Li, Na, K and/or ammonium, and/or characterised in that
the flame retardant in powder form comprises ammonium polyphosphate.

6. Mixture according to claim 1, characterised in that the flame retardant in powder form is agglomerated per se and/or is agglomerated to a polymeric material.

7. Mixture according to claim 1, characterised in that the at least one polymer-based material comprises at least one thermoplastic polymer, wherein the thermoplastic polymer is selected from the group consisting of polyetherimides, polycarbonates, polyphenylene sulfones, polyphenylene oxides, polyether sulfones, acrylonitrile-butadiene-styrene copolymers (ABS), acrylonitrile-styrene-acrylate copolymers (ASA), polyvinyl chloride, polyacrylates, polyesters, polyamides, polyaryletherketones (PAEKs), polyethers, polyurethanes, polyimides, polyamide-imides, polysiloxanes, polyolefins, as well as copolymers which have at least two different repeating units of the aforementioned polymers, and/or at least one polyblend on the basis of at least two of the aforementioned polymers and/or copolymers.

8. Method for preparing a mixture according to claim 1, comprising adjusting a specific particle size distribution having a d50 in the range of at most 60 μm, and a d10 of greater than 20 μm, in the flame retardant in powder form, and mixing this flame retardant in powder form with at least one polymer-based material in powder form.

9. Method according to claim 8, characterised in that adjusting the specific particle size distribution in the flame retardant in powder form comprises removing particles.

10. Method according to claim 1, characterised in that adjusting of the specific particle size distribution in the flame retardant in powder form comprises a step in which
the flame retardant in powder form is agglomerated to itself,
the flame retardant in powder form is agglomerated to a polymeric material,
the flame retardant in powder form is agglomerated by precipitation or drying from a dispersion or solution, and/or
the flame retardant in powder form is first compounded with at least one polymeric material and then micronised to the target particle size.

11. Mixture, obtainable by the method according to claim 1.

12. Three-dimensional object produced by solidification of a pulverulent building material at spatial points corresponding to the cross-section of the three-dimensional object in the respective layer by irradiation, wherein a mixture according to claim 1 is used as the building material.

13. Method for producing a three-dimensional object by solidifying a pulverulent building material at the points corresponding to the cross-section of the three-dimensional object in the respective layer, wherein a mixture according to claim 1 is used as the building material and the building material is selectively solidified by the action of electromagnetic radiation emitted from a radiation source.

14. System for producing three-dimensional objects by solidifying a pulverulent building material at the locations in the respective layer which correspond to the cross-section of the three-dimensional object, wherein the system comprises at least one radiation source designed to emit electromagnetic radiation, a process chamber acting as an open container, which is formed with a container wall, a support arranged in the process chamber, wherein the process chamber and the support are movable in vertical direction relative to each other, with a storage container and a coater movable in horizontal direction, wherein the storage container is at least partially filled with a mixture according to claim 1.

15. Method according to claim 13, wherein the radiation source emits electromagnetic radiation of a wavelength in the range of 640±7 nm, or electromagnetic radiation of a wavelength in the range of 4.8 to 8.3 μm, wherein the radiation source comprises at least one laser.

16. A method of additively manufacturing a three-dimensional object by selective solidification of a building material at the cross-section points of the three-dimensional object in the corresponding layers, in particular according to claim 13.

17. A mixture according to claim 1, wherein the at least one polymer-based material comprises at least one thermoplastic polymer, wherein the at least one thermoplastic polymer comprises PA6, PA6.6, PA11, PA12, PA6.13, PA10.12, PA5, PA5.10, a polypropylene-polyethylene copolymer, a thermoplastic polyurethane and/or a thermoplastic polyamide elastomer.
